(19) United States
(12) Patent Application Publication
(10) Pub. No.: US 2006/0239611 A1
(43) Pub. Date: Oct. 26, 2006

(54) Optical collimator

(76) Inventors: Hirokazu Tanaka, Shiga-Ken (JP); Masaaki Kadomi, Shiga-ken (JP)

Correspondence Address: J C Patents, 4 Venture Suite 250, Irvine, CA, 92618, US

(21) Appl. No.: 10/550,276

(22) PCT Filed: Mar. 22, 2004
(86) PCT No.: PCT/JP04/03849

§ 371 Date: Jun. 19, 2006

(30) Foreign Application Priority Data
Mar. 20, 2003 (JP) 2003-077503
Dec. 22, 2003 (JP) 2003-424782

(51) Int. Cl. G02B 6/32

(52) U.S. Cl. 385/33

(57) ABSTRACT

An optical collimator comprises a sleeve, a partially spherical lens and a capillary tube holding an optical fiber. The sleeve has an inner hole aligned concentrically with an outer surface of the sleeve. The partially spherical lens has a columnar portion fixed into the inner hole of the sleeve and translucent spherical surfaces at both ends of the columnar portion. An optical axis of the translucent spherical surfaces is positioned eccentrically with respect to a center axis of the outer surface of the sleeve. The capillary tube is fixed into the inner hole of the sleeve, holding an optical fiber at a position decentered with respect to the center axis of the outer surface of the sleeve, in a state of an angled end face of the optical fiber facing to the partially spherical lens.

### FIELD OF THE INVENTION

The present invention relates to an optical collimator that uses a capillary tube holding an optical fiber for optical communications at a center, a partially spherical lens having a columnar portion and translucent spherical surfaces, and a sleeve aligning the axes of the optical fiber in the capillary tube and the partially spherical lens with each other.

### BACKGROUND OF THE INVENTION

When a high-speed and large-capacity optical fiber communications system is constructed, many optical devices are used for the system. Some of them include optical devices that extract an optical signal having an arbitrary wavelength from among multiple optical signals, which have multiplexed wavelengths, and optical devices that use an optical crystal for matching phases of optical signals. And many optical collimators are used therein which each convert a widening optical signal emitted from an optical fiber into collimated beam or condense collimated beam onto the optical fiber.

As shown in FIG. 6, a conventional optical collimator 1 using a partially spherical lens is assembled by inserting a capillary tube 4 holding an optical fiber 5 and having an angled polished surface 4a for prevention of reflection signal from an end face 5a of the optical fiber 5, and the partially spherical lens into a sleeve 2, aligning them so that they are at optically appropriate position and the optical collimator 1 perform correctly, and bonding them using an adhesive 6.

As a technique concerning such an optical system, Patent Document 1 discloses that an angled polished optical element having a given shape and refractive index is used, to eliminate eccentricity of collimated beam entering/outgoing with respect to the center axis of an optical collimator that uses a partially spherical lens. Patent Document 2 discloses that the optical axis of an optical fiber and a collimator lens is eccentric from the center axis of an outer surface of a sleeve holding the optical fiber and the collimator lens. In addition, Patent Document 3 discloses an optical collimator, which achieves parallel beam by giving translation deviation between the center axis of an optical fiber and the center axis of a lens in accordance with the polished angle of an optical fiber end face. Patent Document 4 discloses an optical connector in which the center of a tubular housing is defined as the centerline of a collimated beam emitted through a spherical lens. Further, Patent Document 5 discloses an optical fiber collimator in which the optical axis of an optical fiber is decentered with respect to the center of a lens, and an eccentricity is set so that the center of the lens and the center of a light beam from the optical fiber entering the lens are brought into approximate coincidence with each other. Patent Document 6 discloses a collimator, in which the optical axis of a beam outgoing from a lens is parallel to the optical axis of an optical fiber. Patent Document 7 discloses a fiber collimator in which an approximately columnar lens and a fiber end of a fiber are coaxially housed in a cylindrical lens holder.

[Patent Document 1] JP 2001-56418 A

[Patent Document 2] JP 09-258059 A

[Patent Document 3] JP 62-235909 A

[Patent Document 4] JP 02-111904 A

[Patent Document 5] JP 2002-196180 A

[Patent Document 6] JP 05-157992 A

[Patent Document 7] JP 09-274160 A

The conventional structure shown in FIG. 6 uses the capillary tube 4 holding the optical fiber 5 and having the angled polished surface 4a for preventing reflection signal from the end face 5a of the optical fiber 5. Therefore, light is emitted from the end face 5a of the optical fiber 5 in accordance with a law of refraction in an inclined direction with respect to the optical axis Y of the capillary tube. As a result, there is a problem in that eccentricity δ occurs between the optical axis Z of the collimated beam 7 emitted from the optical collimator 1 and the center axis A of the outer surface of the optical collimator 1.

Also, when an optical function component 8 is assembled using optical collimators 1 having the conventional structure and an optical function element 8a as shown in FIG. 7, the optical axis Z of the collimated beam 7 is decentered with respect to the center axes A of the outer surface of the optical collimators 1, so it is required to bring the decentered directions of the optical collimators 1 into coincidence with each other with precision, which leads to a problem in that workability of assembly is significantly lowered.

Further, when using a capillary tube 14, which holds an optical fiber 15 and an end surface 14a of which is not angled polished, and a sleeve 12, to make collimated beam 17 enter/outgo with respect to the center axis A of an outer surface of an optical collimator 11, as shown in FIG. 8, it becomes impossible to achieve a desired return loss due to angled polishing. Thus, reflection optical signal from an end face 15a of the optical fiber 15 and translucent spherical surfaces 13c of a partially spherical lens 13 becomes extremely large, which makes it impossible to sufficiently prevent reflection optical signal even when an antireflection coating is applied to each surface. This reflection optical signal exerts an adverse influence on a laser light source and the like and therefore becomes a significant practical problem when a high-speed and large-capacity optical fiber communications system is constructed.

In addition, as shown in FIG. 1 of Patent Document 1, when using the angled polished optical element, both end face of which are angled polished parallel to each other, aligning work needs to be performed with precision so that collimated beam enters/outgoes with respect to the center axis of the optical collimator, which significantly lowers workability. Also, the angled polished optical element is inserted into an optical path, so an insertion loss of the optical collimator is increased and when a high-speed and large-capacity optical fiber communications system is constructed, this increased insertion loss becomes a problem.

Further, as shown in FIG. 9 of Patent Document 1, when using a cylindrical metal holder which is cut in a state of inner hole center and outer surface center thereof being displaced from each other, precise working is required through which the outer surface center and the inner hole center are set to be slightly displaced from each other. Also, there exist differences in thermal expansion coefficient among the cylindrical metal holder, the capillary tube holding the optical fiber, and the partially spherical lens. When the differences are large, it is concerned that optical properties will go wrong, because of differences in amount of expansion or shrinkage among the respective construction elements due to changing of a temperature at the time of use. In particular, when stress is concentrated on the partially spherical lens due to occurrence of such expansion differences, the troubles ascribable to the wrongness of the optical properties, such as a refractive index and dispersion, is increased, which leads to a problem with stability of the optical system.

Therefore, under a high-temperature or low-temperature condition, which greatly differs from room temperature, exfoliation occurs to bonding portions of the sleeve, the capillary tube, and the partially spherical lens, which incurs inconvenience such as impairment of essential component properties, changing of a transmission light amount due to occurrence of distortion to the partially spherical lens, changing of a polarization properties, and unstable collimated beam. As a result, the use environment of the optical communications device of this type is limited; in particular, the outdoor use of the optical communications device is significantly limited. In addition, fine optical properties are required in the case of incorporation into an optical device, so a usable temperature range becomes extremely narrow and there occurs a problem in that limitations at the time of use become more severe.

Patent Document 2, as shown in FIG. 9, discloses a structure in which an eccentric sleeve 22 is used to make the optical axis X of an optical fiber 25 and a partially spherical lens 23 eccentric from the center axis B of the outer surface of the eccentric sleeve 22, and to thereby eliminate eccentricity of the optical axis Z of collimated beam 27 entering/outgoing with respect to the center axis A of the outer surface of an optical collimator 21. In this case, the center axis D of the outer surface of the partially spherical lens 23 is not coincident with the optical axis Z of the entering/outgoing collimated beam 27, so that, due to the eccentricity of the axes therebetween, it is not possible to reduce the outer diameter of the partially spherical lens 23 as small as the diameter of the entering/outgoing collimated beam 27 even when the diameter of the entering/outgoing collimated beam 27 is smaller than the outer diameter of the partially spherical lens 23. This poses a serious problem when reducing the optical collimator 21 in diameter while eliminating eccentricity of the optical axis Z of the entering/outgoing collimated beam 27 with respect to the center axis of the outer surface of the optical collimator 21 with the partially spherical lens 23.

FIG. 10 shows an optical collimator 31 having a long working distance to be employed in a mechanical optical switch or the like. The optical collimator 31 uses a partially spherical lens 33 that is relatively large in radius of curvature in order to obtain the long working distance, however, a large radius of curvature means a long focal distance of the partially spherical lens 33. As a result, when an eccentric sleeve 32 is used, the optical axis Z of entering/outgoing collimated beam 37 is greatly decentered from the center axis D of the outer surface of the partially spherical lens 33, and the diameter of the entering/outgoing collimated beam 37 increases as well. This makes it more difficult to reduce the outer diameter of the partially spherical lens 33. Accordingly, it is difficult to reduce the optical collimator 31 in diameter while eliminating decentering of the optical axis Z of the entering/outgoing collimated beam 37 with respect to the center axis of the optical collimator 31 which uses the partially spherical lens 33. The partially spherical lens 33 could be reduced in diameter if the diameter of the entering/outgoing collimated beam 37 and the decentering of the optical axis Z from the center axis D of the outer surface of the partially spherical lens 33 are to be left out of consideration. However, insertion loss in this case is large owing to a loss 37a of the entering/outgoing collimated beam 37 as shown in FIG. 10, which is a grave problem in practical use.

In the case of using the eccentric sleeve to eliminate decentering of entering/outgoing collimated beam with respect to the center axis of the optical collimator as disclosed in Patent Document 2, the center axis of the outer surface of the partially spherical lens does not coincide with the center axis of the entering/outgoing collimated beam. So that, it impossible to reduce the outer diameter of the partially spherical lens as small as the diameter of the entering/outgoing collimated beam even when the diameter of the entering/outgoing collimated beam is smaller than the outer diameter of the partially spherical lens. As a result, the optical collimator is inhibited from having a smaller diameter.

In the case of the optical collimator shown in FIG. 1 of Patent Document 3, which achieves parallel beam by giving translation deviation between the center axis of the optical fiber and the center axis of the lens in accordance with the polished angle of the optical fiber end face, the optical axis of the outgoing parallel beam does not coincide with the center axis of the optical fiber, so that aligning between the optical collimators takes mach labor.

In the structure where the core center line of an optical fiber does not coincide with the optical axis of a light beam as shown in FIG. 2 of Patent Document 4, the optical axis of the light beam has to be coincided with the mechanical axis by, for example, an optical detector, in preparation for subjecting the tubular housing to machining (see FIG. 3 of Patent Document 4). In the case of using a spherical lens that has a flat surface of desired dimensions (see FIG. 4 of Patent Document 4), the angle formed between the flat surface and the optical axis of a beam outgoing an optical fiber has to be aligned strictly upon assembly.

In the structure where the optical axis of the optical fiber is eccentric with respect to the center of a refractive-index-distribution-type rod lens and the eccentricity is set in such a manner that the center of the refractive-index-distribution-type rod lens is made to substantially coincide with the center of the light beam entering the lens, as shown in FIG. 1 of Patent Document 5, if the refractive-index-distribution-type rod lens is replaced by a spherical lens, the center of an outgoing light beam does not coincide with the optical axis of the optical fiber, since the optical axis of the optical fiber is decentered from the center of the lens.

In the structure disclosed in Patent Document 6, the beam outgoing the lens is parallel to, and does not coincide with, the axis of an input side mount. The beam is therefore merely a collimated beam at a certain distance from the axis of the input side mount (see FIG. 3 of Patent Document 6), so that it is necessary to align the collimators with each other while rotating the optical collimators about the axis of the mount.

The optical collimator shown in Patent Document 7 is structured by coaxially housing the approximately columnar lens and the end of the optical fiber in the cylindrical lens holder (see FIG. 1 of Patent Document 7). However, the optical axis of collimated beam outgoing the optical collimator does not coincide with the center axis of the outer surface of the fiber collimator. Therefore, to align the optical collimators with each other, the optical collimators have to be rotated about their axes.

Further, when aligning the conventional optical collimators with each other, even in the case, for example, where the optical collimators are placed to oppose each other on one V-groove at positions, at which their working distance is secured, and under a state, in which the center axes of the outer surfaces of the sleeves coincide with each other, when light is introduced from the optical fiber on one side, it is impossible to obtain a sufficient optical response from the optical fiber on the other side. It is, therefore, required to manually conduct aligning work until a state is obtained in which it is possible to obtain a sufficient optical response and use an automatic aligning apparatus for optical axis or the like.

### DISCLOSURE OF THE INVENTION

An object of the present invention is to provide an optical collimator in which it is not necessary to conduct aligning work for coincidence of decentered directions of entering/outgoing collimated beam with each other at the time of assembling of an optical function component or the like, as in the case of a conventional optical collimator, and allows collimated beam to enter/outgo with respect to the center axis of the outer surface of the optical collimator.

Another object of the present invention is to reduce, as much as possible, degradation of optical properties ascribable to differences in thermal expansion coefficient among a sleeve, a partially spherical lens, and a capillary tube when the optical collimator is in use under various temperature conditions.

Still another object of the present invention is to reduce the diameter of an optical collimator and at the same time to reduce or to dispense with, as much as possible, decentering between the center axis of the outer surface of the optical collimator with a partially spherical lens and the optical axis of entering/outgoing collimated beam.

In order to attain the above objects, the present invention provides an optical collimator comprising a sleeve having an inner hole aligned concentrically with an outer surface of the sleeve, a partially spherical lens having a columnar portion fixed into the inner hole of the sleeve and translucent spherical surfaces at both ends of the columnar portion, an optical axis of the translucent spherical surfaces being positioned eccentrically with respect to a center axis of the outer surface of the sleeve, and a capillary tube fixed into the inner hole of the sleeve, holding an optical fiber at a position decentered with respect to the center axis of the outer surface of the sleeve, in a state of an angled end face of the optical fiber facing to the partially spherical lens.

It is preferred, for the optical collimator of the present invention as structured above, that an optical axis of collimated beam outgoing from an outer one of the translucent spherical surfaces of the partially spherical lens is in a round with radius range of 0.02 mm or less, the center of the round being the center axis of the outer surface of the sleeve, and in an angle range of 0.2° or less with respect to the center axis of the outer surface of the sleeve.

More specially, the optical collimator of the present invention is preferred to comprise a substantially cylindrical sleeve having an inner hole at the center, a partially spherical lens made of glass with an approximately uniform refractive index and having translucent spherical surfaces with approximately the same center of curvature at both ends of a columnar portion with the diameter slightly smaller than the inner diameter of the sleeve, and a capillary tube with the outer diameter slightly smaller than the inner diameter of the sleeve. When the partially spherical lens is fixed into the inner hole of the sleeve, the optical axis of the partially spherical lens resides at a position decentered from the center axis of the outer surface of the sleeve by a predetermined amount and with a predetermined parallelism. When the capillary tube is fixed into the inner hole of the sleeve, the capillary tube holds an optical fiber with an angled end face at a predetermined decentering position with a predetermined parallelism with respect to the center axis of the outer surface of the sleeve. In addition, it is more preferable that an optical axis of collimated beam outgoing from an outer one of the translucent spherical surfaces of the partially spherical lens is in a round with radius range of 0.02 mm or less, the center of the round being the center axis of the outer surface of the sleeve, and in an angle range of 0.2° or less with respect to the center axis of the outer surface of the sleeve.

It is not necessary for the optical collimator of the present invention to conduct aligning work for bringing the decentered directions of entering/outgoing collimated beam into coincidence at the time of assembling of the optical function component or the like, as in the case of the conventional optical collimator. Therefore, it becomes possible to easily produce the optical collimator with which the collimated beam enters/outgoes with respect to the center axis of the outer surface of the optical collimator. In addition, it becomes possible to reduce degradation of optical properties an much as possible ascribable to differences in thermal expansion coefficient among the sleeve, the capillary tube, and the partially spherical lens at the time of use under various temperature conditions. Therefore, it becomes possible to produce an optical function component having high reliability.

Moreover, the optical collimator of the present invention comprises the partially spherical lens the optical axis of which resides at a position decentered from the center axis of the outer surface of the sleeve by a predetermined amount and with a predetermined parallelism, so that the optical axis of entering/outgoing collimated beam can be coincided with the center axis of the outer surface of the partially spherical lens, and the outer diameter of the partially spherical lens can be reduced as small as the diameter of the entering/outgoing collimated beam. The optical collimator can thus be reduced in diameter.

One pair of the optical collimators of the present invention may be arranged to oppose each other at positions, at which a working distance thereof is secured, and under a state, in which the center axes of the outer surfaces of the sleeves coincide with each other. When optical signal is introduced from the optical fiber of the optical collimator on one side, an optical signal response of −30 dB or more is obtained from the optical fiber of the optical collimator on the other side. Whereby, it is not necessary to conduct cumbersome manual aligning work, it becomes possible to perform optical axis aligning of the pair of the optical collimators arranged to oppose each other with ease using an automatic aligning apparatus for optical axis or the like, and it becomes possible to assemble an optical device with unprecedented high efficiency.

When the sleeve is made of glass or crystallized glass in the above structure, a highly precise cylindricity of the sleeve can be achieved through a drawing process and the sleeves can be mass-produced with stability and with efficiency. In addition, the surface of the sleeve produced through the drawing process is fire-polished, and such the surface is not necessary to be polished, so that the sleeve is produced at low cost.

When the capillary tube is made of glass or crystallized glass in the above structure, a highly precise cylindricity and an eccentricity (also referred to as the “off-axis amount”) of the capillary tube can be achieved through a drawing process and the capillary tube can be mass-produced with stability and with efficiency. In addition, the surface of the capillary tube produced through a drawing process is fire-polished, and such the surface is not necessary to be polished, so that the capillary tube is produced at low cost.

In the above structure, differences in thermal expansion coefficient among the sleeve, the partially spherical lens, and the capillary tube may be within 50×10⁻⁷/K or less. Whereby, it becomes possible to reduce, as much as possible, degradation of optical properties ascribable to the differences in thermal expansion coefficient among them, so that the optical collimator capable of maintaining stable performance with respect to changing of environmental temperature can be realized.

In the above structure, the capillary tube is preferable to be produced through a drawing process.

### BRIEF DESCRIPTION OF THE DRAWINGS

FIG. 1A is a sectional view of an optical collimator according to an embodiment of the present invention and FIG. 1B is a side view of the optical collimator.

FIG. 2A is a sectional view of a capillary tube used in the optical collimator according to the embodiment of the present invention and FIG. 2B is a side view of the capillary tube.

FIG. 3A is a sectional view of a partially spherical lens used in the optical collimator according to the embodiment of the present invention and FIG. 3B is a side view of the partially spherical lens.

FIG. 4A is a sectional view of a sleeve used in the optical collimator according to the embodiment of the present invention and FIG. 4B is a side view of the sleeve.

FIG. 5A is a sectional view of an optical collimator having a long working distance according to another embodiment of the present invention and FIG. 5B is a side view of the optical collimator.

FIG. 6A is a sectional view of a conventional optical collimator in a direction parallel to optical axis thereof and FIG. 6B is a sectional view showing the optical collimator in a direction perpendicular to the optical axis.

FIG. 7 is a sectional view of an optical function component that uses a conventional optical collimator.

FIG. 8A is a sectional view of a conventional optical collimator in which an end face of an optical fiber is not angled polished and FIG. 8B is a side view of the optical collimator.

FIG. 9A is a sectional view of a conventional optical collimator with an eccentric sleeve and FIG. 9B is a side view of the optical collimator.

FIG. 10A is a sectional view of a conventional optical collimator having a long operation distance that uses an eccentric sleeve and FIG. 10B is a side view of the optical collimator.

FIG. 11 is a sectional view wherein a pair of the optical collimators are arranged to oppose each other on a V-groove at positions, at which their working distance is secured, and under a state, in which the center axes of the outer surfaces of the sleeves coincide with each other.

### BEST MODE FOR CARRYING OUT THE INVENTION

Embodiments of the present invention will be described below with reference to the drawings.

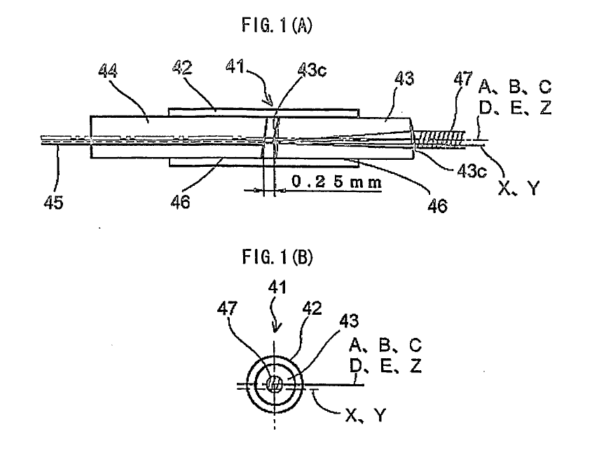

FIGS. 1 to 4 show an optical collimator 41 according to an embodiment of the present invention. The optical collimator 41 comprises a cylindrical sleeve 42 having an inner hole 42a at the center thereof, a partially spherical lens 43 made of glass with an approximately uniform refractive index and having translucent spherical surfaces 43c with approximately the same center of curvature at both ends 43b of a columnar portion 43a, and a capillary tube 44. When the partially spherical lens 43 is fixed into the inner hole 42a of the sleeve 42, the optical axis X of the partially spherical lens 43 resides at a position decentered from the center axis B of the outer surface of the sleeve 42 by a predetermined amount. When the capillary tube 44 is fixed into the inner hole 42a of the sleeve 42, the capillary tube 44 holds an optical fiber 45 at a position decentered from the center axis B of the outer surface of the sleeve 42 by a predetermined amount. The partially spherical lens 43 and the capillary tube 44, which holds the optical fiber 45, are fixed at an optically appropriate position in the inner hole 42a of the sleeve 42 to allow the optical collimator 41 to operate properly, so that collimated beam 47 enters/outgoes with respect to the center axis A of the outer surface of the optical collimator 41. That is, the optical axis Z of the collimated beam 47 outgoing from an outer one of the translucent spherical surfaces 43c of the partially spherical lens 43 is in a round with radius range of 0.02 mm or less, the center of the round being the center axis B of the outer surface of the sleeve 42, and in an angle range of 0.2° or less with respect to the center axis B of the outer surface of the sleeve 42.

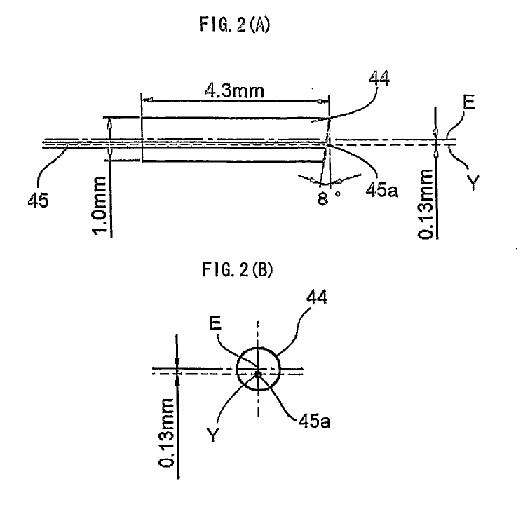

As shown in FIG. 2, the capillary tube 44 constituting the optical collimator 41 holds the optical fiber 45 at a position decentered, by a predetermined amount, with respect to the center axis E of the outer surface the capillary tube 44. Accordingly, when the capillary tube 44 is inserted into the inner hole 42a of the sleeve 42, the optical axis Y of the optical fiber 45 held by the capillary tube 44 is decentered from the center axis B of the outer surface of the sleeve 42 by the predetermined amount. The center axis B of the outer surface of the sleeve 42 coincides with the center axis of the inner hole 42a.

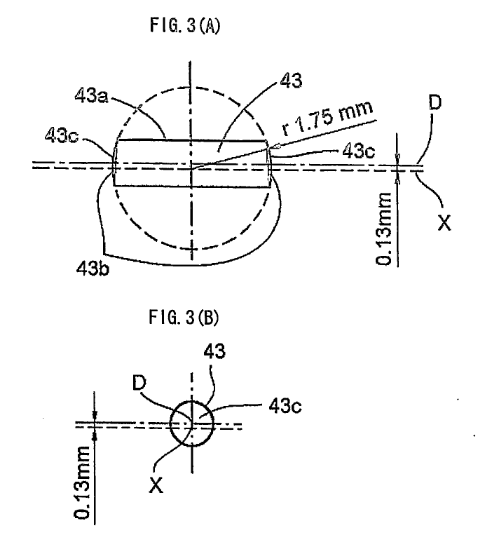

As shown in FIG. 3, the partially spherical lens 43 constituting the optical collimator 41 has the optical axis X at a position decentered, by a predetermined amount, with respect to the center axis D of the outer surface of the partially spherical lens 43. Accordingly, when the partially spherical lens 43 is inserted into the inner hole 42a of the sleeve 42, the optical axis X of the partially spherical lens 43 is decentered from the center axis B of the outer surface of the sleeve 42 by the predetermined amount.

For the partially spherical lens 43, it is possible to use such a material that is made of optical glass or the like having an approximately uniform refractive index and that gets into a spherical lens of high focus accuracy by machining into a true spherical shape. The partially spherical lens 43 obtained by grinding the circumference of a spherical lens with high sphericity is suitable for reducing the optical collimator 41 in size and diameter. Optical glass BK7, K3, TaF3, LaF01, LaSF015, or the like is preferred for the partially spherical lens 43.

At least one of the sleeve 42 and the capillary tube 44 is preferably to be made of glass or crystallized glass. Such the sleeve 42 and/or the capillary tube 44 can be produced through a drawing process stably at low cost with high precision and efficiency. In addition, the surface of the sleeve 42 and/or the capillary tube 44 produced through the drawing process is fire-polished to be smooth.

For instance, when the partially spherical lens 43 is made of optical glass LaSF015 to have a thermal expansion coefficient of 74×10⁻⁷/K, the sleeve 42 is made of borosilicate glass to have a thermal expansion coefficient of 51×10⁻⁷/K, and the capillary tube 44 is made of crystallized glass to have a thermal expansion coefficient of 27×10⁻⁷/K, upon a change in environment temperature by 60° C., a change in eccentricity of the optical axis Z of the collimated beam 47 with respect to the center axis A of the outer surface of the optical collimator 41, due to differences in thermal expansion coefficient among them, becomes 0.0003 mm (0.3 μm) or less. In addition, a change in outgoing angle of deviation (beam inclination angle) of the collimated beam 47 becomes 0.01° or less.

On the other hand, when the sleeve 42 is made of a general stainless steel, SUS 304 (thermal expansion coefficient: 184×10⁻⁷/K), differences in thermal expansion coefficient among them is 100×10⁻⁷/K or higher, and a change in eccentricity of the optical axis Z of the collimated beam 47 with respect to the center axis A of the outer surface of the optical collimator 41 due to the differences becomes about 0.0009 mm (0.9 μm), and also a change in outgoing angle of deviation (beam inclination angle) of the collimated beam 47 becomes about 0.03°. The amount of each of the changes degenerates by about three times as large as those when the sleeve 42 is made of borosilicate glass.

It is therefore preferable to produce the optical collimator 41 from members differences in thermal expansion coefficient of which is within 50×10⁻⁷/K, in order to obtain stable optical properties against a change in environment temperature.

An eccentricity δ between the center axis D of the outer surface and the optical axis X of the partially spherical lens 43, and an eccentricity δ between the center axis E of the outer surface of and the capillary tube 44 and the optical axis Y of the optical fiber 45, which constitute the optical collimator 41 shown in FIG. 1, is expressed as follows respectively.
[Expression 1]

$$δ = \frac{{n}_{3}}{2 ( {n}_{3} - {n}_{2} )} \cdot r \cdot tan [ \{ arcsin ( \frac{{n}_{1}}{{n}_{2}} sin θ ) \} - θ ]$$

Where, the refractive index of the core portion of the optical fiber 45 is referred to as “n₁”, the refractive index of the air in an in-the-atmosphere case is referred to as “n₂”, the refractive index of the partially spherical lens 43 is referred to as “n₃”, the radius of curvature of the partially spherical lens 43 is referred to as “r”, and the angled polished angle of an end face 45a of the optical fiber 45 is referred to as “θ”.

Table 1 shows an example of each parameter in the case where optical glass LaSF015 is used as the material of the partially spherical lens 43.

TABLE 1

| Item | Value |
|---|---|
| N₁ | 1.4682 |
| N₂ | 1.0 |
| n₃ | 1.7753 |
| R | 1.75 mm |
| Θ | 8.0° |

When calculated from the Expression 1 using each parameter described above, the eccentricity δ becomes 0.13 mm. Therefore, it is sufficient that the eccentricity δ of the partially spherical lens 43 and of the capillary tube 44 used for the optical collimator 41 shown in FIG. 1 is set to 0.13 mm in the case of the parameters shown in Table 1.

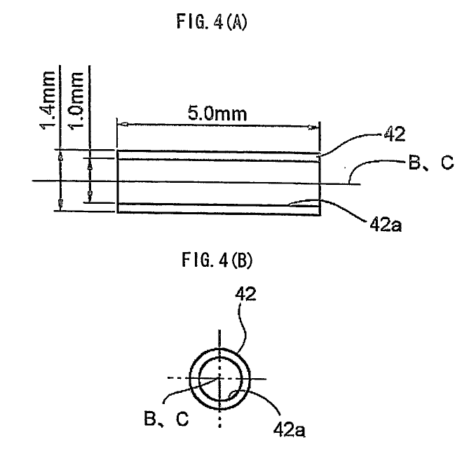

As shown in FIG. 4, the sleeve 42 in this embodiment is made of glass and measures 1.4 mm in outer diameter, 1.0 mm in inner diameter, and 5.0 mm in total length. The center axis B of the outer surface of the sleeve 42 coincides with the center axis C of the inner hole 42a of the sleeve 42. The sleeve 42 may be made of crystallized glass instead. In addition, the sleeve 42 may be a metal or ceramic split sleeve, as far as differences in thermal expansion coefficient from the partially spherical lens 43 and the capillary tube 44 is within 50×10⁻⁷/K.

As shown in FIG. 3, the partially spherical lens 43 in this embodiment is made of optical glass LaSF015 with an approximately uniform refractive index and the radius of curvature r of the translucent spherical surfaces 43c is 1.75 mm. The eccentricity δ between the center axis D of the outer surface and the optical axis X of the partially spherical lens 43 is 0.13 mm. An antireflection coating (not shown in the figures) is formed on each of the translucent spherical surfaces 43c of the partially spherical lens 43 in order to reduce reflection of an optical signal less.

As shown in FIG. 2, the capillary tube 44 in this embodiment is made of glass and measures 1.0 mm in outer diameter and 4.3 mm in total length. With the single mode optical fiber 45 held in the inner hole of the capillary tube 44, the eccentricity δ between the center axis E of the outer surface of the capillary tube 44 and the optical axis Y of the optical fiber 45 is 0.13 mm. An end face of the capillary tube 44 is angled polished at 8° with respect to a plane perpendicular to the optical axis Y, and further an antireflection coating (not shown in the figures) is formed on the end face 45a, in order to reduce reflection return optical signal.

As shown in FIG. 1, the capillary tube 44 and the partially spherical lens 43 as the above are inserted in the inner hole 42a of the sleeve 42 respectively and then bonded by an adhesive 46 such as an epoxy-based resin at positions at which an optically appropriate distance of 0.25 mm is secured, so that the optical collimator performs correctly.

Next, Table 2 shows measurement result of the insertion loss, a return loss, the outgoing deviation angle of collimated beam 47 (also called as beam inclination angle) of the optical collimator 41, and the eccentricity of the optical axis Z of the collimated beam 47 with respect to the center axis A of the outer surface of the optical collimator 41 (also called as optical axis eccentricity).

TABLE 2

| | | | Optical axis |
|---|---|---|---|
| | | Outgoing | eccentricity of |
| Insertion loss | Return loss | deviation angle | collimated beam |
| 0.2 dB or less | 60 dB or more | 0.1° or less | 0.015 mm or less |

Light having a wavelength of 1550 nm is used for measuring these values and the insertion loss is measured under a state where a pair of the optical collimators 41 are arranged to oppose each other so that the working distance becomes 17.5 mm. Here, the working distance means a spatial distance between the translucent spherical surfaces 43c of the partially spherical lenses 43 oppose to each other.

As shown in Table 2, as to the insertion loss and the return loss of the embodiment, performance that is equal to or better than that in a conventional case is exhibited and there is no practical problem.

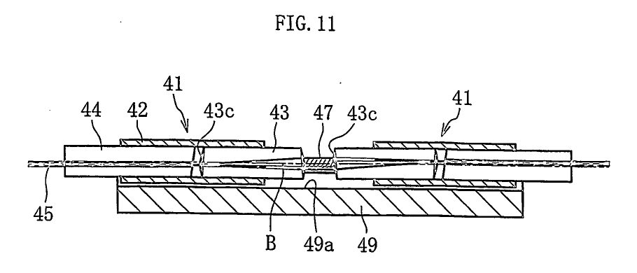

Also, the outgoing deviation angle of the embodiment is 0.1° or less, which is an extremely favorable value as compared with the conventional case. Further, in this embodiment, the eccentricity of the optical axis of the collimated beam 47 is 0.015 mm or less. Thus, for instance, when a pair of the optical collimators 41 are placed to oppose each other on a V-groove 49a formed in a V-groove substrate 49 at positions as shown in FIG. 11, at which their working distance is secured, and under a state, in which the center axes B of the outer surfaces of the sleeves 42 coincide with each other, an optical signal response of −30 dB or more at which an automatic aligning apparatus can operate, is obtained even under anon-aligned state. Measurements have been made for various optical systems and an optical signal response of −10 dB or more was obtained in most of the optical systems. An optical response of −5 dB to −1 dB was obtained for an input signal in the optical systems processed in a usual manner. In the optical system shown in FIG. 2, for example, the insertion loss of the optical signal was about 1.5 dB, which was sufficient for optical signal response. So when an optical function component, for which it is required to conduct an aligning work between the optical collimators 41, is assembled using a automatic aligning apparatus or the like, working efficiency is significantly improved as compared with the conventional case.

Next, a method of assembling the optical collimator 21 will be described.

First, a long capillary tube having an outer diameter of 1.0±0.5 μm, an eccentricity of 0.13 mm between the center axis E of the outer surface and the center axis Y of an inner hole, and an inner diameter slightly larger than the diameter of the optical fiber 45 is produced through, for example, heating and drawing a glass base material having a similar shape in section to the capillary tube 44. Next, as shown in FIG. 2, the optical fiber 45 is inserted in and bonded to the inner hole of the long capillary tube. After, the long capillary tube is cut together with the optical fiber 45 into a predetermined length, and then subjected to given machining to obtain the capillary tubes 44 each having an outer diameter of 1.0±0.5 μm and a total length of 4.3 mm. When the capillary tube 44 is inserted into the inner hole 42a of the sleeve 42, the capillary tube 44 holds the optical fiber 45 at a position decentered, by a predetermined amount (the eccentricity is 0.13 mm in this example), with respect to the center axis B of the outer surface of the sleeve 42. The outer surface of the capillary tube 44 is marked or has an orientation flat machining portion (not shown in the figures) to indicate the decentering direction. The capillary tube 44 may be produced through grinding the outer surface thereof mechanically decentered.

Also, a spherical lens as indicated by the dashed line in FIG. 3 which has high sphericity and is available at a low price, is used to be ground into a columnar shape so that the optical axis X is set in a position decentered with respect to the center axis D of the outer surface by 0.13 mm. Thus the partially spherical lens 43 is produced, which has a diameter of less than 1.0 mm, and the translucent spherical surfaces 43c at both ends of which have the same center of curvature and radius of curvature r of 1.75 mm. When the partially spherical lens 43 is fixed into the inner hole 42a of the sleeve 42, the partially spherical lens 43 has the optical axis X in a position decentered from the center axis B of the outer surface of the sleeve 42 by a predetermined amount (the eccentricity is 0.13 mm in this example). The outer surface of the partially spherical lens 43 is marked or has an orientation flat machining portion (not shown in the figures) to indicate the decentering direction.

Subsequently, for example, a glass base material having a similar shape in section to the sleeve 42 is heated and drawn, and then cut into a predetermined length, to produce the transparent sleeve 42 shown in FIG. 4 which has an outer diameter of 1.4 mm and an inner diameter of 1.0 mm. The outer surface of the sleeve 42 may be marked or have an orientation flat machining portion (not shown in the figures) to match the decentering direction with respect to the partially spherical lens 43 and the capillary tube 44, so that the optical collimator 41 can be assembled with ease.

Then, the partially spherical lens 43 is inserted in the inner hole 42a of the sleeve 42 and is positioned with reference to the markings thereof to be bonded with the adhesive 46. After the adhesive 46 has completely cured, the capillary tube 44 is inserted in the inner hole 42a of the sleeve 42 and positioned with reference to the markings thereof and through observation and measurement of the distance between the end face 45a of the optical fiber 45 and the translucent spherical surfaces 43c of the partially spherical lens 43 to be 0.25 mm±2 μm, to be bonded with the adhesive 46. The optical collimator 41 shown in FIG. 1 is thus completed.

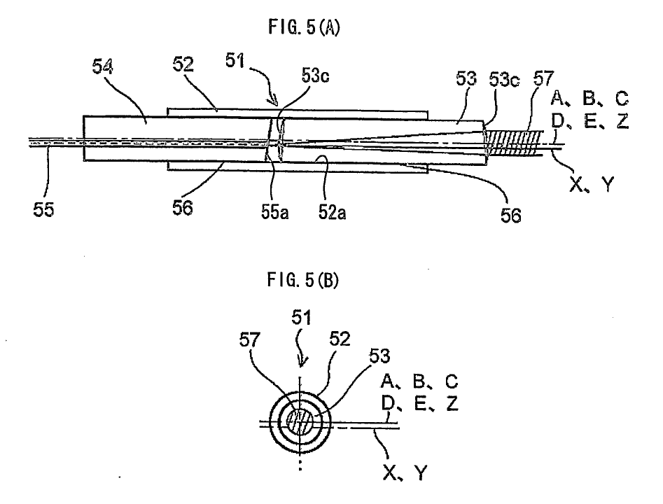

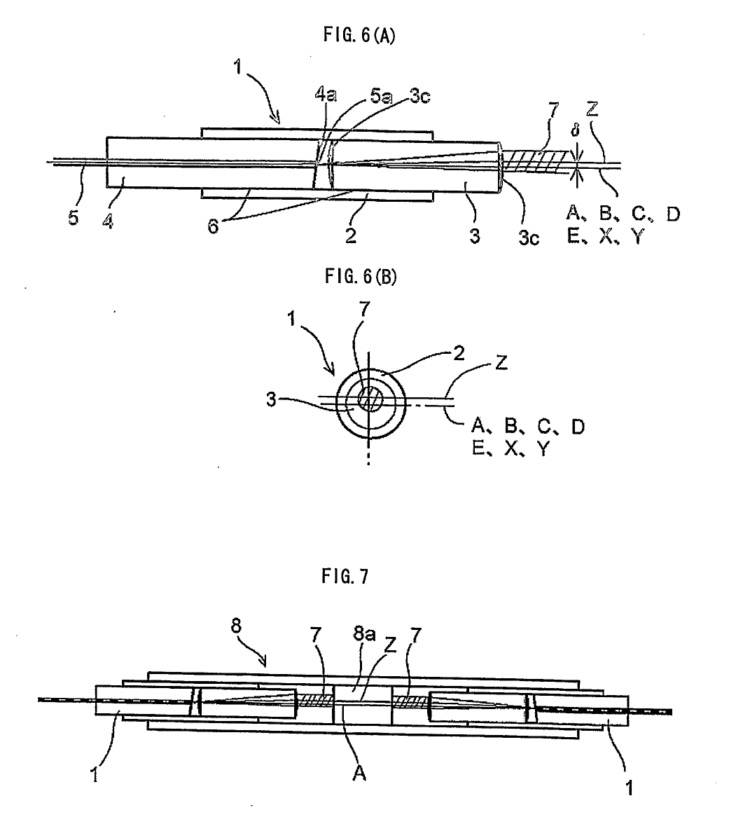

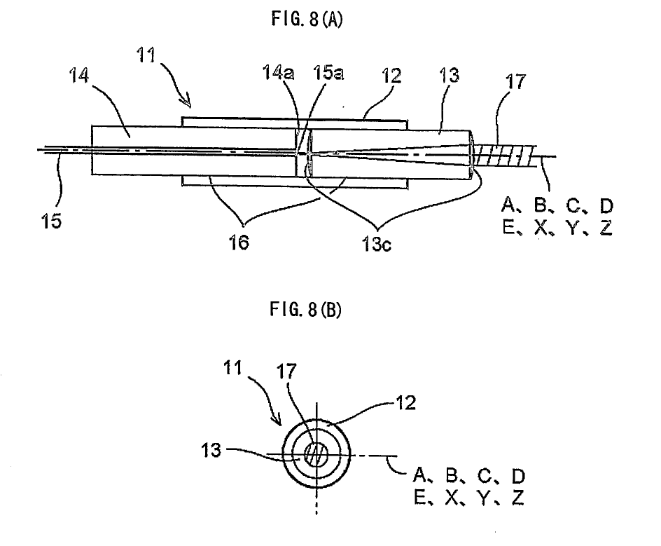

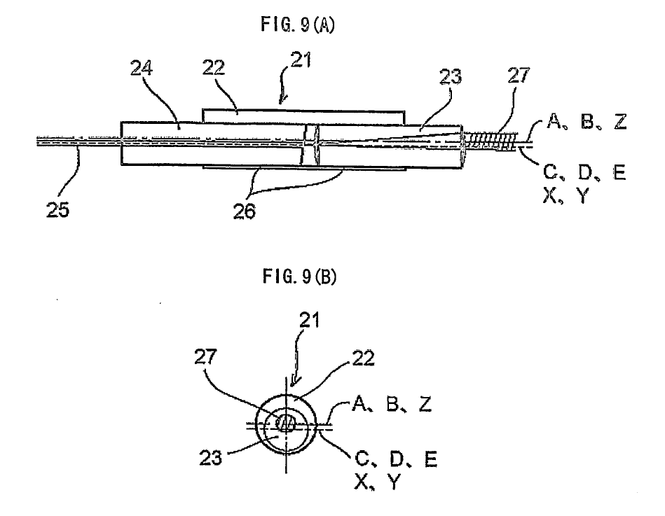

FIG. 5 shows an optical collimator 51 according to another embodiment of the present invention. The optical collimator 51 comprises a cylindrical sleeve 52 having an inner hole 52a at the center thereof, a partially spherical lens 53 made of glass with an approximately uniform refractive index and having translucent spherical surfaces 53c with approximately the same center of curvature at both ends 53b of a columnar portion 53a, and a capillary tube 54. When the partially spherical lens 53 is fixed into the inner hole 52a of the sleeve 52, the optical axis X of the partially spherical lens 53 resides at a position decentered from the center axis B of the outer surface of the sleeve 52 by a predetermined amount. When the capillary tube 54 is fixed into the inner hole 52a of the sleeve 52, the capillary tube 54 holds an optical fiber 55 at a position decentered from the center axis B of the outer surface of the sleeve 52 by a predetermined amount. The partially spherical lens 53 and the capillary tube 54, which holds the optical fiber 55, are fixed at an optically appropriate position in the inner hole 52a of the sleeve 52 to allow the optical collimator 51 to operate properly, so that collimated beam 57 enters/outgoes with respect to the center axis A of the outer surface of the optical collimator 51. That is, the optical axis Z of the collimated beam 57 outgoing from an outer one of the translucent spherical surfaces 53c of the partially spherical lens 53 is in a round with radius range of 0.02 mm or less, the center of the round being the center axis B of the outer surface of the sleeve 52, and in an angle range of 0.2° or less with respect to the center axis B of the outer surface of the sleeve 52.

An eccentricity δ between the center axis D of the outer surface and the optical axis X of the partially spherical lens 53, and an eccentricity δ between the center axis E of the outer surface of and the capillary tube 54 and the optical axis Y of the optical fiber 55, which constitute the optical collimator 51 shown in FIG. 5, is expressed by the Expression 1 as the above respectively. Where, the refractive index of the core portion of the optical fiber 55 is referred to as “n₁”, the refractive index of the air in an in-the-atmosphere case is referred to as “n₂”, the refractive index of the partially spherical lens 53 is referred to as “n₃”, the radius of curvature of the partially spherical lens 53 is referred to as “r”, and the angled polished angle of an end face 55a of the optical fiber 55 is referred to as “θ”.

Table 3 shows an example of each parameter in the case where optical glass LaSF015 is used as the material of the partially spherical lens 53.

TABLE 3

| Item | Value |
|---|---|
| n₁ | 1.4492 |
| n₂ | 1.0 |
| n₃ | 1.7753 |
| R | 2.75 mm |
| Θ | 8.0° |

When calculated from the Expression 1 using each parameter described above, the eccentricity δ becomes 0.20 mm. Therefore, it is sufficient that the eccentricity δ of the partially spherical lens 53 and of the capillary tube 54 used for the optical collimator 51 having a long working distance shown in FIG. 1 is set to 0.20 mm in the case of the parameters shown in Table 3.

The sleeve 52 in this embodiment is made of glass and measures 1.4 mm in outer diameter, 1.0 mm in inner diameter, and 8.0 mm in total length. The center axis B of the outer surface of the sleeve 52 coincides with the center axis C of the inner hole 52a of the sleeve 52. The sleeve 52 may be made of crystallized glass instead. In addition, the sleeve may be a metal or ceramic split sleeve, as far as differences in thermal expansion coefficient from the partially spherical lens 53 and the capillary tube 54 is within 50×10⁻⁷/K. The partially spherical lens 53 in this embodiment is made of optical glass LaSF015 with an approximately uniform refractive index and the radius of curvature r of the translucent spherical surfaces 53c is 2.75 mm. The eccentricity δ between the center axis D of the outer surface and the optical axis X of the partially spherical lens 53 is 0.20 mm. An antireflection coating (not shown in the figures) is formed on each of the translucent spherical surfaces 53c of the partially spherical lens 53 in order to reduce reflection of an optical signal less.

The capillary tube 54 in this embodiment is made of glass and measures 1.0 mm in outer diameter and 4.3 mm in total length. With the single mode optical fiber 55 held in the inner hole of the capillary tube 54, the eccentricity δ between the center axis E of the outer surface of the capillary tube 54 and the optical axis Y of the optical fiber 55 is 0.20 mm. An end face of the capillary tube 54 is angled polished at 8° with respect to a plane perpendicular to the optical axis Y, and further an antireflection coating (not shown in the figures) is formed on the end face 55a, in order to reduce reflection return optical signal.

The capillary tube 54 and the partially spherical lens 53 as the above are inserted in the inner hole 52a of the sleeve 52 respectively and then bonded by an adhesive 56 such as an epoxy-based resin at positions at which an optically appropriate distance of 0.40 mm is secured, so that the optical collimator performs correctly.

Next, Table 4 shows measurement result of the insertion loss, a return loss, the outgoing deviation angle of collimated beam 57 (also called as beam inclination angle) of the optical collimator 51 having a long working distance, and the eccentricity of the optical axis Z of the collimated beam 57 with respect to the center axis A of the outer surface of the optical collimator 51 (also called as optical axis eccentricity).

TABLE 4

| | | | Optical axis |
|---|---|---|---|
| | | Outgoing | eccentricity of |
| Insertion loss | Return loss | deviation angle | collimated beam |
| 0.3 dB or less | 60 dB or more | 0.1° or less | 0.015 mm or less |

Light having a wavelength of 1550 nm is used for measuring these values and the insertion loss is measured under a state where a pair of the optical collimators 51 are arranged to oppose each other so that the working distance becomes 150 mm. Here, the working distance means a spatial distance between the translucent spherical surfaces 53c of the partially spherical lenses 53 oppose to each other.

As shown in Table 4, as to the insertion loss and the return loss of the embodiment, performance that is equal to or better than that in a conventional case is exhibited and there is no practical problem.

Also, the outgoing deviation angle of the embodiment is 0.1° or less, which is an extremely favorable value as compared with the conventional case having a long working distance. Further, in this embodiment, the eccentricity of the optical axis of the collimated beam 57 is 0.015 mm or less. Thus, for instance, when a pair of the optical collimators 51 are placed to oppose each other on a V-groove 49a at positions as shown in FIG. 11, at which their working distance is secured, and under a state, in which the center axes B of the outer surfaces of the sleeves 52 coincide with each other, an optical signal response of −30 dB or more at which an automatic aligning apparatus can operate, is obtained even under a non-aligned state. In the optical systems shown in FIG. 5, for example, the insertion loss of the optical signal was about 1.0 dB in least value, which was sufficient for optical signal response. So when an optical function component, for which it is required to conduct an aligning work between the optical collimators 51 having a long working distance, is assembled using a automatic aligning apparatus or the like, working efficiency is significantly improved as compared with the conventional case.

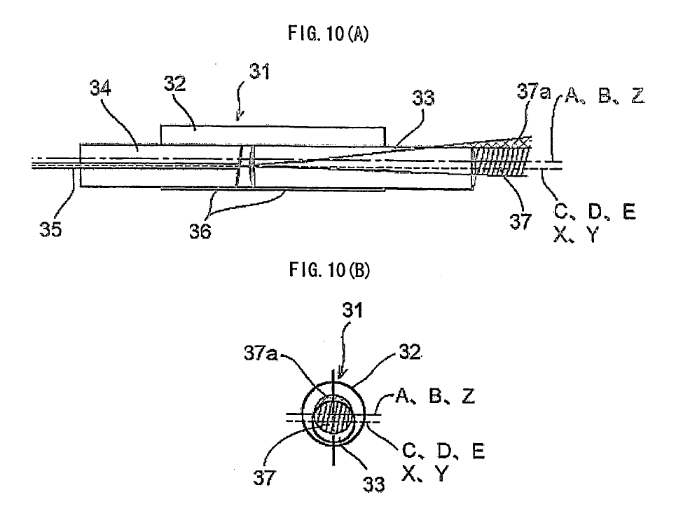

Moreover, despite having as long a working distance as 150 mm, the optical collimator 51 of this embodiment achieves a reduction in outer diameter down to 1.4 mm by reducing the outer diameter of the partially spherical lens 53 to 1.0 mm. In the case of using the eccentric sleeve 32 to build the optical collimator 31 having a working distance of 150 mm as shown in FIG. 10, a reduction in outer diameter of the partially spherical lens 33 to 1.0 mm causes the loss 37a in the entering/outgoing collimated beam 37. As a result, an insertion loss of about 1.0 dB appears, presenting a serious problem in practical use. Even if the outer diameter of the partially spherical lens 33 is set to, for example, 1.25 mm so as to prevent the loss 37a in the entering/outgoing collimated beam 37, it is physically impossible to produce the eccentric sleeve 32 having an outer diameter of 1.4 mm and an inner diameter of 1.0 mm, since the eccentricity between the center axis X of the outer surface of the partially spherical lens 33 and the optical axis Z of the entering/outgoing collimated beam 37 is 0.20 mm. Consequently, it is necessary to use, for example, the eccentric sleeve 32 having the outer diameter of 1.8 mm. That is, the optical collimator 51 of this embodiment is achieved a reduction in diameter about 0.6 times, with changing into cross sectional area in the optical axis direction, as compared to the conventional optical collimator 31.

1. An optical collimator comprising:
a sleeve having an inner hole aligned concentrically with an outer surface of the sleeve;
a partially spherical lens having a columnar portion fixed into the inner hole of the sleeve and translucent spherical surfaces at both ends of the columnar portion, an optical axis of the translucent spherical surfaces being positioned eccentrically with respect to a center axis of the outer surface of the sleeve; and
a capillary tube fixed into the inner hole of the sleeve, holding an optical fiber at a position decentered with respect to the center axis of the outer surface of the sleeve, in a state of an angled end face of the optical fiber facing to the partially spherical lens.

2. An optical collimator according to claim 1, wherein an optical axis of collimated beam outgoing from an outer one of the translucent spherical surfaces of the partially spherical lens is in a round with radius range of 0.02 mm or less, the center of the round being the center axis of the outer surface of the sleeve, and in an angle range of 0.2° or less with respect to the center axis of the outer surface of the sleeve.

3. An optical collimator according to claim 1, wherein, when one pair of the optical collimators are arranged to oppose each other at positions, at which a working distance thereof is secured, and under a state, in which the center axes of the outer surfaces of the sleeves coincide with each other, and when optical signal is introduced from the optical fiber of the optical collimator on one side, an optical signal response of −30 dB or more is obtained from the optical fiber of the optical collimator on the other side.

4. An optical collimator according to claim 1, wherein the sleeve is made of one of glass and crystallized glass.

5. An optical collimator according to claim 1, wherein the sleeve is a split sleeve.

6. An optical collimator according to claim 1, wherein the capillary tube is made of one of glass and crystallized glass.

7. An optical collimator according to claim 1, wherein differences in thermal expansion coefficient among the sleeve, the partially spherical lens, and the capillary tube is within 50×10⁻⁷/K.

8. An optical collimator according to claim 1, wherein the capillary tube is produced through a drawing process.
